(19) United States
(12) Patent Application Publication
(10) Pub. No.: US 2017/0294031 A1
(43) Pub. Date: Oct. 12, 2017

(54) SKIN TONE ENHANCEMENT FOR GHOST IMAGES

(71) Applicant: MorphoTrust USA, LLC, Billerica, MA (US)

(72) Inventors: Yecheng Wu, Lexington, MA (US); Robert Jones, Andover, MA (US); Daoshen Bi, Boxborough, MA (US)

(21) Appl. No.: 15/484,545

(22) Filed: Apr. 11, 2017

Related U.S. Application Data
(60) Provisional application No. 62/320,959, filed on Apr. 11, 2016.

(51) Int. Cl. G06T 11/00; G06T 7/90

(52) U.S. Cl. CPC G06T 11/001; G06T 7/90; G06T 7/194

(57) ABSTRACT

Methods, systems, and apparatus, including computer programs encoded on a computer storage medium, for enhancing skin tone in a ghost image are disclosed. In one aspect, a method includes the actions of receiving a color image. The actions further include converting the color image to a grayscale image. The actions further include generating a foreground image by removing background pixels from the grayscale image. The actions further include determining a foreground pixel value range of the pixel values of the foreground image. The actions further include generating a transfer function based on the foreground pixel value range, a minimum pixel value, and a maximum pixel value. The actions further include generating a transferred image by applying the transfer function to each pixel of the foreground image. The actions further include generating a monochrome image of the transferred image.

### CROSS REFERENCE TO RELATED APPLICATION

This application claims the benefit of U.S. Application No. 62/320,959, filed on Apr. 11, 2016, which is incorporated by reference.

### FIELD

This specification relates to security features for identification documents.

### BACKGROUND

Identification (“ID”) documents play a critical role in today's society. One example of an ID document is an ID card. ID documents are used on a daily basis to prove identity, to verify age, to access a secure area, to evidence driving privileges, to cash a check, and so on. Airplane passengers are required to show an ID document during check in, security screening, and prior to boarding their flight. In addition, because we live in an ever-evolving cashless society, ID documents are used to make payments, access an automated teller machine (ATM), debit an account, make a payment, and the like.

### SUMMARY

Identification cards may include a ghost image that is additional image of the cardholder's face. The ghost image may be based on the primary photo of the cardholder's face. For example, the ghost image may be a half-translucent copy the primary photo and be slightly offset in relation to the primary photo. The ghost image may be viewable only from particular angles. For example, the ghost image may only be viewable when the viewer looks at the identification card straight on.

In some instances, ghost images of individuals with lighter skin tone and hair and ghost images of individuals with darker skin tone and hair may appear washed out and unrecognizable because of the small variation in color or grayscale level that exists in the picture. To correct this problem, a system adjusts the pixel values of the image by generating a look-up table, or transfer function, to apply to the pixel values. For individuals with light skin and hair and individuals with dark skin and hair, the pixel values may be clustered in small pixel value ranges. By applying the look-up table, or transfer function, the system is able to utilize the entire pixel range to represent the individual instead of just the pixel value range that inherently exists in the image.

According to an innovative aspect of the subject matter described in this application, a method for enhancing skin tone in a ghost image includes the actions of receiving a color image; converting the color image to a grayscale image; generating a foreground image by removing background pixels from the grayscale image; determining a foreground pixel value range of the pixel values of the foreground image; generating a transfer function based on the foreground pixel value range, a minimum pixel value, and a maximum pixel value; generating a transferred image by applying the transfer function to each pixel of the foreground image; and generating a monochrome image of the transferred image.

These and other implementations can each optionally include one or more of the following features. The actions further comprise generating a negative image of the grayscale image. The action of generating the foreground image by removing the background pixels from the grayscale image includes generating the foreground image by removing background pixels from the negative image. The actions further comprise before generating the transfer function based on the foreground pixel value range, the minimum pixel value, and the maximum pixel value: identifying a low group of pixel values that are the lowest pixel values of the foreground image; identifying a high group of pixel values that are the highest pixel values of the foreground image; replacing each pixel value in the low group of pixel values with a highest pixel value of the low group of pixel values; and replacing each pixel value in the high group of pixel values with a lowest pixel value of the high group of pixel values. A number of pixels in the low group is equal to a number of pixels in the high group. A number of pixel values in the low group is equal to a number of pixel values in the high group. The transfer function is a linear transfer function. The monochrome image is a dithered monochrome image. The dithered monochrome image is a halftone image. The transfer function maps (i) a lowest foreground pixel value to the minimum pixel value and (ii) a highest foreground pixel value to the maximum pixel value. The transfer function maps each foreground pixel value to a different pixel value of the transferred image. The transfer function is a non-linear transfer function.

Other implementations of this aspect include corresponding systems, apparatus, and computer programs recorded on computer storage devices, each configured to perform the operations of the methods.

The subject matter described in this application may have one or more of the following advantages. A system may create a ghost image that more clearly illustrates the features of the individual. The ghost image may not appear washed out for individuals with darker skin tone and hair or for individuals with lighter skin tone and hair.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example identification card with a ghost image.

FIG. 2 is flowchart of an example process for enhancing skin tone in a ghost image.

FIG. 3 illustrates example ghost images.

FIG. 4 illustrates an example of a computing device and a mobile computing device.

Like reference symbols in the various drawings indicate like elements.

### DETAILED DESCRIPTION

Identification documents, such as driver's licenses or passports, are frequently used to back up identity assertions of document holders. These identification documents are also used to verify ages, prove driving privileges, access a secure area, cash a check, and so on. Identification cards often become the target for counterfeiting and fraud. To deter such deleterious acts, security features can be embedded into identification documents. The security features on the identification documents can provide authorities and card holders with a sense of security to preserve, for example, the trust in the asserted identity. Large number of transactions may rely on the authenticity of these underlying identification documents. As such, the security features on the identification documents can become paramount to support an identification document as a genuine and up-to-date identity proof.

Unlike currencies that are also in wide use by the populace, identification documents are unique to the particular document holder. Therefore, the security features on identification documents can incorporate personalization element to attest to ownership and further heighten the difficulty for counterfeiting and fakery. Implementations disclosed herein incorporate laser-engraved security features underneath the surface of an identification document. Some implementations may embed personally identifiable information in the laser-engraved features. Some implementations may provide biometric representations in the laser engraved features. In some instances, the personally identifiable information or the biometric representation can be embedded into a metalized holographic image underneath the surface of the identification document.

Identification documents (“ID documents”) are broadly defined to include, for example, credit cards, bank cards, phone cards, passports, driver's licenses, network access cards, employee badges, debit cards, security cards, visas, immigration documentation, national ID cards, citizenship cards, permanent resident cards (e.g., green cards), Medicare cards, Medicaid cards, social security cards, security badges, certificates, identification cards or documents, voter registration cards, police ID cards, border crossing cards, legal instruments, security clearance badges and cards, gun permits, gift certificates or cards, membership cards or badges, etc., etc. Also, the terms “document,” “card,” “badge” and “documentation” are used interchangeably throughout this patent application.

Many types of identification cards and documents, such as driving licenses, national or government identification cards, bank cards, credit cards, controlled access cards and smart cards, carry thereon certain items of information which relate to the identity of the bearer. Examples of such information include name, address, birth date, signature and photographic image. The cards or documents may in addition carry other variant data (i.e., data specific to a particular card or document, for example an employee number) and invariant data (i.e., data common to a large number of cards, for example the name of an employer). All of the cards described above will hereinafter be generically referred to as “ID documents.”

The subject matter described below allows a manufacturer to personalize credentials in a manner that an image is possible to be viewed in several ways. When a person's skin tone is either too dark or too light or lacks contrast, the quality of a ghost image is affected. This technology will automatically enhance the skin tone to get the optimal skin tone and contrast for better ghost image printing quality.

A ghost image may be a half-translucent copy of a photograph, graphic or even a line of text. In some implementations, such an image is slightly offset in relation to the original image, and it can be placed elsewhere on the identification card. The ghost image may be difficult to reproduce using a color printer since such a device tends to degrade image quality. In some implementations, a ghost image is created by changing the opacity of an image using an identification software, and may be a low cost and effective security feature.

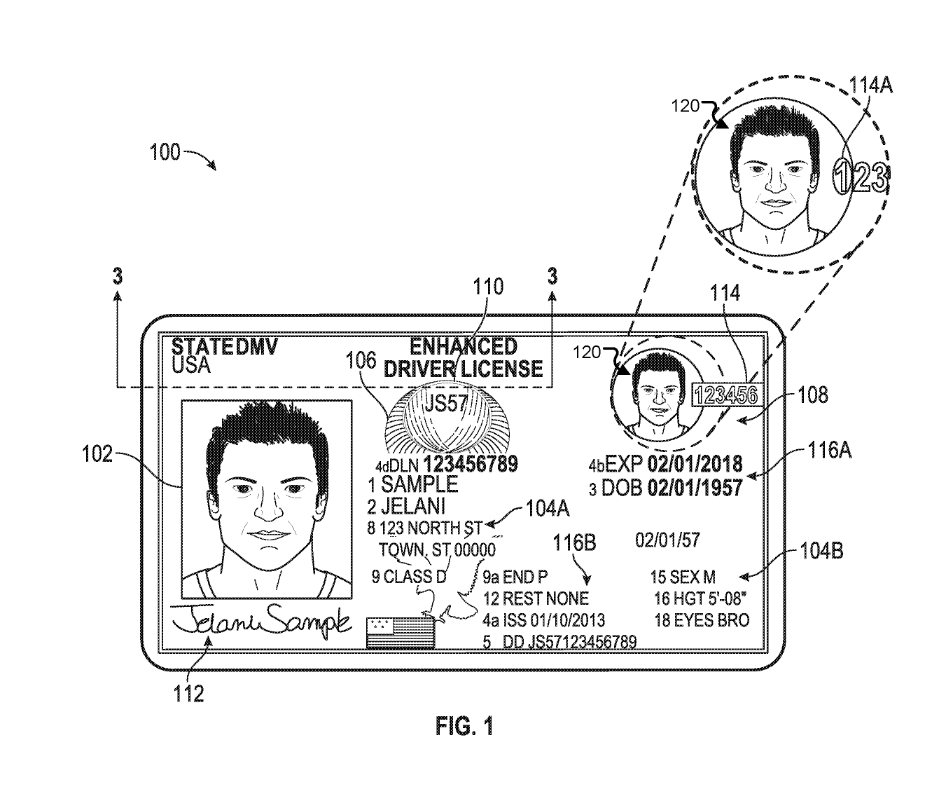

FIG. 1 illustrates an example identification document 100 including photo 102 of the card holder. ID document 100 also includes personally identifiable information (PII) area 104A and 104B, emblem area 106, companion biometric information area 108, labelling information area 110, signature area 112, laser-shadow security feature 114, and card issuance information areas 116A and 116B.

In more detail, ID document 100 can be formed using a core material such as polyvinyl chloride (PVC), TESLIN®, or polycarbonate (PC). Photo 102 may include a facial portrait of the card holder. Photo 102 may be a color image, or a monochromatic image. ID document 100 may include companion biometric information area 108, which can include a screened-back or “ghost” version 120 of photo 102. In at least one embodiment, the ghost image 120 can be a color or grayscale halftone version of photo 102. Ghost image or photo 120 may also be preferably visible under normal viewing conditions. In some implementations, ID document 100 may include a covert image in the companion biometric information area 108 that corresponds to photo 102 and is not visible under “normal” viewing conditions. In some implementations, ID document 100 may include an optically variable photo in companion biometric information area 108. Some implementations may include an image of a print-print or palm-print of the cardholder in companion biometric information area 108.

Labelling information 110 generally encodes fixed information that does not change for card holders. For example, the fixed information may include jurisdictional information or employer information to show the issuing authority. Card issuance information area 116A and 116B generally records information on card expiration date or card issuance date.

Personally identifiable information (PII) area 104 shows the name, residential address, and date of birth of the card holder. “Personalization”, “Personalized data” and “variable” data are used interchangeably herein, and refer at least to data, characters, symbols, codes, graphics, images, and other information or marking, whether human readable or machine readable, that is (or can be) “personal to” or “specific to” a specific cardholder or group of cardholders. Personalized data can include data that is unique to a specific cardholder (such as biometric information, image information, serial numbers, Social Security Numbers, privileges a cardholder may have, etc.), but is not limited to unique data. Personalized data can include some data, such as birthdate, height, weight, eye color, address, etc., that are personal to a specific cardholder but not necessarily unique to that cardholder (for example, other cardholders might share the same personal data, such as birthdate). In at least some implementations, personal/variable data can include some fixed data, as well.

For example, in at least some embodiments, personalized data refers to any data that is not pre-printed onto an ID document in advance, so such personalized data can include both data that is cardholder-specific and data that is common to many cardholders. Variable data can, for example, be printed on an information-bearing layer of the ID card using thermal printing ribbons and thermal printheads. Personalized and/or fixed data is also intended to refer to information that is (or can be) cross-linked to other information on the identification document or to the identification document's issuer. For example, personalized data may include a lot number, inventory control number, manufacturing production number, serial number, digital signature, etc. Such personalized or fixed data can, for example, indicate the lot or batch of material that was used to make the identification document, what operator and/or manufacturing station made the identification document and when, etc. Further details about such personalized data on identification cards may be found in the following commonly assigned patent applications, each of which is incorporated by reference: “Inventory Management System and Methods for Secure Document Issuance,” 60/529,847, filed Dec. 15, 2003, and counterpart non-provisional application of the same title by Gyi, Kaylor and Dong, filed on Dec. 15, 2004, Ser. No. 10/848,526; “Uniquely Linking Security Elements in Identification Documents,” Ser. No. 60/488,536, filed Jul. 17, 2003, and non-provisional counter-part Ser. No. 10/893,149; and “Protection of Identification Documents Using Open Cryptography,” Ser. No. 10/734,614, filed Dec. 12, 2003.

Information recorded in PII area 104 may include, for example, portions of PII or a biometric representation of the card holder, for example, name of card holder, residential address information, gender information, biometric information such as height, weight, eye color, and hair color.

Emblem area 106 may include a KINEGRAM®, hologram, optically variable device (OVD), UV or IR indicia, etc. Some implementations provide security feature implemented through laser engrave or laser write technologies to embed portions of PII on emblem area 106. Laser-engraving refers to using laser to carve a structural appearance. Laser-writing refers to the use of high-intensity laser focusing on metalized structures to obliterate the metal component, thereby carving out a void. In some instances, these technologies can cause portions of PII to be carved into metalized holographic images of emblem area 106. Some implementations provide emblem area 106 to embed a biometric representation of the card holder, such as a facial portrait, or a finger-print. In some instances, laser-engraving or laser-writing technologies can cause the biometric representation to be carved into metalized holographic images of emblem area 106.

Using the ghost image printing technique, a manufacturer is able to print a vivid flipping image (e.g., an image that a viewer can see at one angle and cannot see at another angle). Creating a vivid flipping image is accomplished by developing a transfer layer on a carrier web either in a std D2T2 ribbon or on a separate single ribbon available in larger printers (e.g., Muhlbauer). This layer is a thermal transfer coating that contains optically active material such as pearlescent particulates/pigments which can be available in different colors (e.g., silver, gold, blue, etc.). The transfer binder may be any polymer that allows incorporation of the pigments and is transparent and bonds well to the card surface in printing. The image is structured in a number of ways such that the image is viewable and either flips to a transparent mode or from a positive to a negative mode.

The transfer layer can house IR or UV particulates, dyes, or pigments that give the transferred pixels UV or IR functionality, in addition to their optical function. The transferring materials may be magnified by vacuum depositing other materials to the transfer layer. Materials such as metallic oxides or HRI materials diffract light waves so that irradiance is possible in the transferred pixels.

The transfer layer function can also be amplified by incorporation of a combination of elements or compounds that have light functioning characteristics, e.g., color shifting functionality, or glitter via dispersion of a variety of metallic materials.

In some instances, a person's skin tone is either too dark or too light or lacks contrast, the quality of the printed ghost image may be affected because image details lost during the image processing and dithering process. This technology automatically enhances the skin tone to increase image contrast to maintain the most details for the face area for better ghost image printing quality.

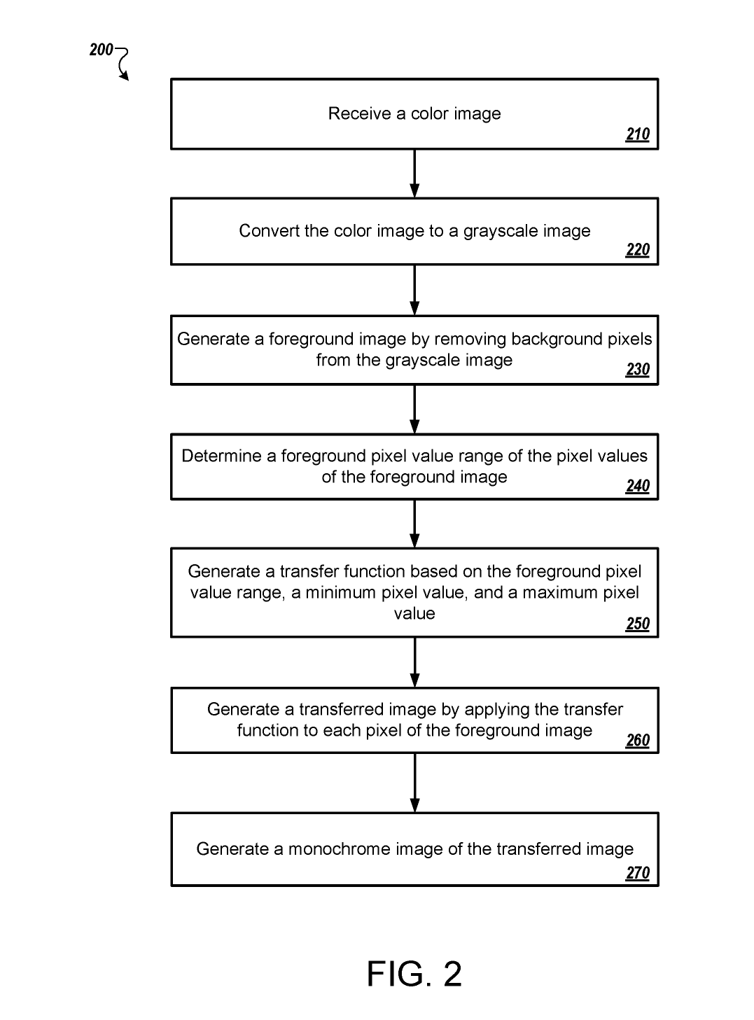

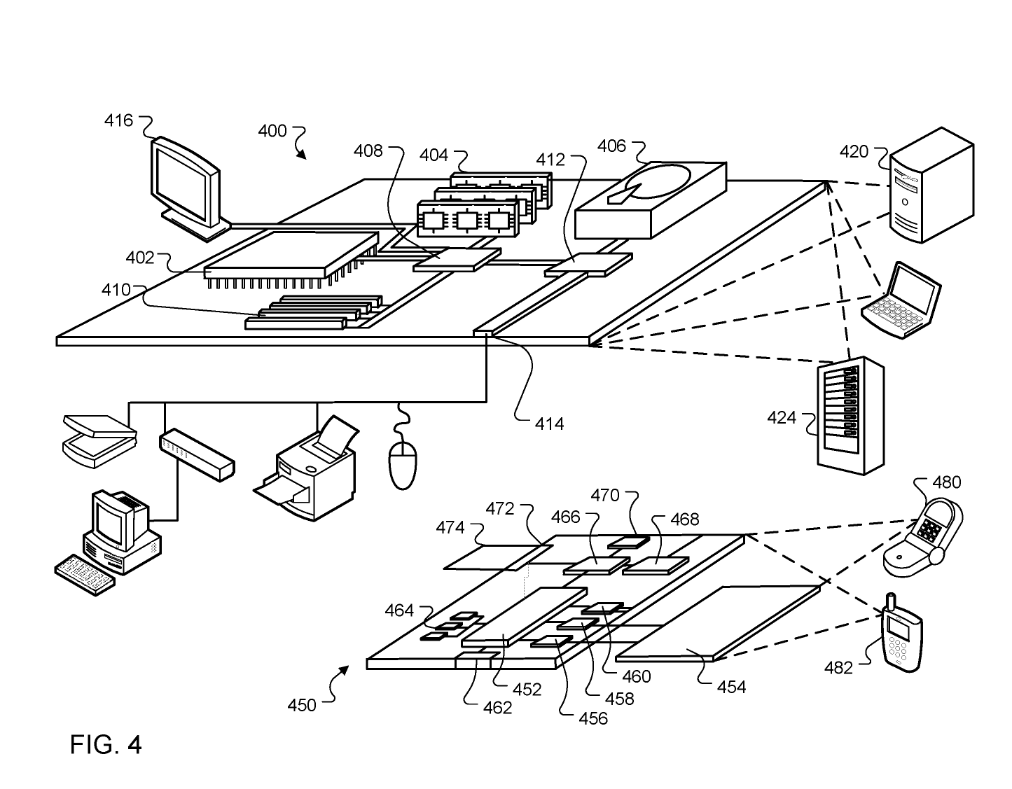

FIG. 2 illustrates an example process 200 for enhancing skin tone in a ghost image. In general, the process 200 adjusts the pixel values for the pixels of an image to improve the contrast of a ghost image for individuals with lighter skin tones and darker skin tones. The process 200 will be described as being performed by a computer system comprising one or more computers, for example, system 400 as shown in FIG. 4.

The system receives a color image (210). In some implementations, the color image is an image of a person's face. For example, the color image may be a color version of photo 102. The color image may be composed of pixels where each pixel has a particular pixel value. For example, pixel at row fifty-two and column ten may have a pixel value of 0x3c5d. The possible range of pixel values may be from 0x0 to 0xffff.

The system converts the color image to a grayscale image (220). In some implementations, the number of pixels in the grayscale image is the same as the number of pixels in the color image. In some implementations, the range of pixel values in the grayscale image may be different than the range of pixel values in the color image. For example, the possible range of pixel values may be from 0x0 to 0xff. The pixel at row fifty-two and column ten may have a pixel value of 0x6e. In some implementations, the system generates a negative image of the grayscale image. The system may subtract the pixel value of each pixel from the maximum pixel value. For example, the system may subtract 0x6e from 0xff to get 0x91. In the negative image, the pixel at row fifty-two and column ten has a pixel value of 0x91. In this instance, the process 200 continues with the negative image of the grayscale image.

The system generates a foreground image by removing background pixels from the grayscale image (230). In implementations where the grayscale image is an image of a person's face, the system automatically identifies the boundary between the edge of the person's face and the background. In some implementations, a user may adjust the boundary in instances where the boundary identified by the system is not accurate. In some implementations, the user may identify the boundary without the system.

The system determines a foreground pixel value range of the pixel values of the foreground image (240). The foreground pixel value range represents the range of pixel values present in the foreground image. For example, the smallest pixel value may be the pixel at row one hundred twenty and column seventy-six and may be 0x14. The largest pixel value may be at row thirty-three and column eighty-eight and may be 0xe8. In this example, the pixel value range would be 0x14 to 0xe8. The foreground image does not include any pixels with pixel values between 0x00 and 0x14 or between 0xe8 and 0xff.

The system generates a transfer function based on the foreground pixel value range, a minimum pixel value, and a maximum pixel value (250). The purpose of the transfer function is to translate the pixel values of each pixel of the foreground image to the range of pixel values that include the minimum pixel value and the maximum pixel value. For example, the pixel value range of the foreground image may be 0x14 to 0xe8, where the minimum possible pixel value is 0x00 and the maximum possible pixel value if 0xff. The transfer function translates the pixels with a pixel value of 0x14 to 0x00 and pixels with a pixel value of 0xe8 to 0xff. Pixels with pixel values between 0x14 and 0xe8 translate to pixels with pixel values between the entire range of 0x00 and 0xff. In some implementations, the transfer function is a linear transfer function where the translated pixel values are evenly distributed in the entire range of possible pixel values. In some implementations, the transfer function is a non-linear transfer function such as an exponential function, polynomial-based function, logarithmic function, Gaussian function, trigonometric function, or any similar non-linear function. In some implementations, the transfer function may be a look-up table. The look-up table may map a specific pixel value of the foreground image to another specific pixel value. While the pixel values of the foreground image may not utilize the entire pixel range, e.g., 0x00 to 0xff, the mapped pixel values do include pixel values within the entire pixel range. For example, the pixel value of 0x14 may map to 0x00, and the pixel value of 0xe8 may map to 0xff. A pixel value of 0x5a may map to 0x71.

In some implementations, the system generates a histogram of the pixel values in the foreground image. The histogram may illustrate the number of pixels that have each pixel value. For example, the histogram may illustrate that there are five pixels with a pixel value of 0x68 and that there are seven pixels with a pixel value of 0x77. Depending on the skin tone of the person in the image, the average pixel value be different. Persons with darker skin tone may have an average pixel value near one end of the pixel range while persons with lighter skin tone may have an average pixel value near the other end of the pixel range. In some implementations, the histogram may illustrate the number of pixels for different pixel ranges of pixel values. For example, the histogram may group pixel ranges of eight. In this instance, the histogram may illustrate that there are thirty-one pixels with a pixel value between 0x40 and 0x47.

In some implementations, the system adjusts the pixel values for those pixels that have pixel values that are near the ends of the pixel value range for the foreground image. The system may adjust the pixel values for noise reduction. The system may group the pixels with the lowest pixel values and update the pixel values to the highest pixel value in the group. For example, the histogram may indicate that the lowest pixel values are 0x14, 0x15, and 0x16 with one pixel, three pixels, and four pixels, respectively. The system may change the pixel value for each of these pixels to 0x16. Similarly, the system may group the pixels with the highest pixel values and update the pixel values to the lowest pixel value in the group. For example, the histogram may indicate that the highest pixel values are 0xe8, 0xe7, and 0xe6 with one pixel, five pixels, and six pixels, respectively. The system may change the pixel value for each of these pixels to 0xe6.

In some implementations, the system may adjust the same number, or nearly the same number, of pixels on the low end as the high end. The number that the system adjusts may vary based on the distribution of the histogram. For example, the system may adjust ten percent of the pixels, five percent on the high end and five percent on the low end. The number may also be a constant, such as ten pixels on the high end and ten pixels on the low end. Following the example above, the system may adjust the eight pixels with pixel values are 0x14, 0x15, and 0x16. The system may adjust the six pixels with the pixel values of 0xe8 and 0xe7. The number of adjusted pixels on the low end is eight, and the number of adjusted pixels on the high end is six. The system may be unable to adjust the same number of pixels on the high end as the low end. In this instance, the system adjusts the number of pixels nearest to the target number of pixels to be adjusted. In some implementations, the number of pixels adjusted may be different on the high end compared to the low end. For example, the system may adjust four percent of the pixels on the high end and three percent of pixels on the low end.

In some implementations, the system adjusts pixels on the high end and the low end based on pixel values. For example, the system may adjust the pixels with the lowest three pixel values and the pixels with the highest three pixel values. The system may adjust the pixels with pixel values of 0x14, 0x15, and 0x16, independent of the number of pixels with those pixel values. The system may adjust the pixels with pixel values of 0xe8, 0xe7, and 0xe6, independent of the number of pixels with those pixel values. As another example, the system may adjust the pixels with the lowest four pixel values and the pixels with the highest six pixel values. In some implementations, the system may adjust pixels with the pixel values with lowest particular percentage of pixel values and the pixels with the pixel values with the highest particular percentage of pixel values. For example, the foreground image may include one hundred pixel values, and the system adjust the lowest five percent of pixel values and the highest five percent of pixel values. With one hundred pixel values, the system adjusts the pixels with the highest five pixel values and the pixels with the lowest five pixel values.

The system generates a transferred image by applying the transfer function to each pixel of the foreground image (260). In instances, where the system adjusts pixel values on the high end and the low end, the system applies the transfer function to the adjusted image. By applying the transfer function to the pixels of foreground image, the system takes advantage of the entire range of pixel values. In this case, the features of a person's face in the image may become more prominent. In some implementations, the transfer function translates each pixel value of the foreground image to a particular value in the full range of pixel values. For example, each pixel with a pixel value of 0x3b may translate the pixel value of 0x53. In some implementations, the transfer function translates each pixel value of the foreground image to a particular pixel value range. For example, the system translates the four pixels with the pixel value of 0x3b to the pixels 0x52, 0x53, and 0x54. The system may translate one pixel each to pixel values 0x52 and 0x53 and two pixels to pixel value 0x54.

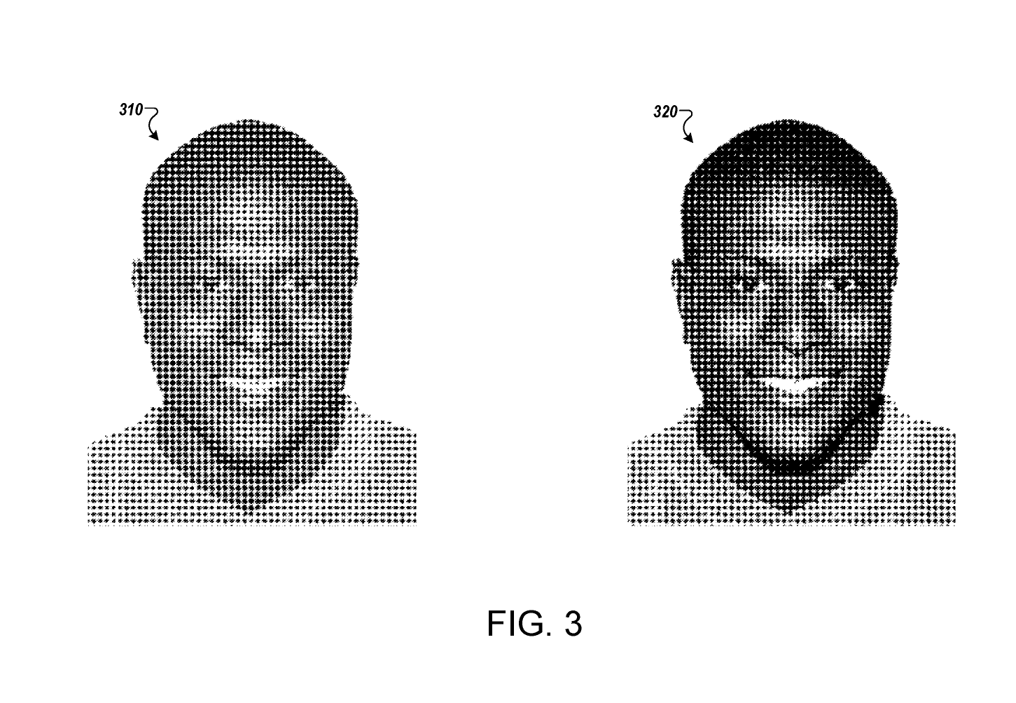

The system generates a monochrome image of the transferred image (270). In some implementations the monochrome image is a halftone image, for example, a black and white halftone image. In some implementations, the system generates the monochrome image using a dithering method. FIG. 3 illustrates example ghost images 310 and 320. The ghost images 310 and 320 represent images of a person's face with a dark skin tone. Ghost image 310 is an example halftone image that is generated without process 200. For example, the system generates ghost image 310 without applying the transfer function. Ghost image 320 is an example halftone image that is generated with process 200. The facial features of the ghost image 320 are more distinguishable than the facial features of the ghost image 310.

Returning to FIG. 1 and in some implementations, ID document 100 may further include a machine readable zone (MRZ) that includes a machine readable code encoding, for example, information correlatable with the PII. In one example, the machine readable code may include only the name or portions of the name (e.g., the first name, the last name, or the first three letters of the last name) of the holder. In another example, the machine readable code may include a numerical string encoding portions of the data of birth. In yet another example, the machine readable code may include portions of the residential address. In all these examples, the portions of the PII as encoded in the machine-readable code can be correlated with the printed PII, as shown in area 104.

An example ID document can include a core layer (which can be pre-printed), such as a light-colored, opaque material (e.g., TESLIN (available from PPG Industries) or polyvinyl chloride (PVC) material). The core is laminated with a transparent material, such as clear PVC to form a so-called “card blank”. Information, such as variable personal information (e.g., photographic information), is printed on the card blank using a method such as Dye Diffusion Thermal Transfer (“D2T2”) printing (described further below and also described in commonly assigned U.S. Pat. No. 6,066,594, which is incorporated herein by reference in its entirety.) The information can, for example, include an indicium or indicia, such as the invariant or nonvarying information common to a large number of identification documents, for example the name and logo of the organization issuing the documents. The information may be formed by any known process capable of forming the indicium on the specific core material used.

Commercial systems for issuing ID documents are of two main types, namely so-called “central” issue (CI), and so-called “on-the-spot” or “over-the-counter” (OTC) issue. Both types are applicable to the laser write technology as disclosed herein.

CI type ID documents are not immediately provided to the bearer, but are later issued to the bearer from a central location. For example, in one type of CI environment, a bearer reports to a document station where data is collected, the data are forwarded to a central location where the card is produced, and the card is forwarded to the bearer, often by mail.

Another illustrative example of a CI assembling process occurs in a setting where a driver passes a driving test, but then receives her license in the mail from a CI facility a short time later. Still another illustrative example of a CI assembling process occurs in a setting where a driver renews her license by mail or over the Internet, then receives a driver's license card through the mail.

In contrast, a CI assembling process is more of a bulk process facility, where many cards are produced in a centralized facility, one after another. (For example, picture a setting where a driver passes a driving test, but then receives her license in the mail from a CI facility a short time later. The CI facility may process thousands of cards in a continuous manner.)

Centrally issued identification documents can be produced from digitally stored information and generally include an opaque core material (also referred to as “substrate”), such as paper or plastic, sandwiched between two layers of clear plastic laminate, such as polyester, to protect the aforementioned items of information from wear, exposure to the elements and tampering. The materials used in such CI identification documents can offer the ultimate in durability. In addition, centrally issued digital identification documents generally offer a higher level of security than OTC identification documents because they offer the ability to pre-print the core of the central issue document with security features such as “micro-printing”, ultra-violet security features, security indicia and other features currently unique to centrally issued identification documents.

In addition, a CI assembling process can be more of a bulk process facility, in which many cards are produced in a centralized facility, one after another. The CI facility may, for example, process thousands of cards in a continuous manner. Because the processing occurs in bulk, CI can have an increase in efficiency as compared to some OTC processes, especially those OTC processes that run intermittently. Thus, CI processes can sometimes have a lower cost per ID document, if a large volume of ID documents are manufactured.

In contrast to CI identification documents, OTC identification documents are issued immediately to a bearer who is present at a document-issuing station. An OTC assembling process provides an ID document “on-the-spot”. (An illustrative example of an OTC assembling process is a Department of Motor Vehicles (“DMV”) setting where a driver's license is issued to person, on the spot, after a successful exam.). In some instances, the very nature of the OTC assembling process results in small, sometimes compact, printing and card assemblers for printing the ID document. This, an OTC card issuing process can be by its nature an intermittent-in comparison to a continuous-process.

OTC identification documents of the types mentioned above can take a number of forms, depending on cost and desired features. Some OTC ID documents include highly plasticized poly(vinyl chloride) or have a composite structure with polyester laminated to 0.5-2.0 mil (13-51 μm) poly(vinyl chloride) film, which provides a suitable receiving layer for heat transferable dyes which form a photographic image, together with any variant or invariant data required for the identification of the bearer. These data are subsequently protected to varying degrees by clear, thin (0.125-0.250 mil, 3-6 μm) overlay patches applied at the printhead, holographic hot stamp foils (0.125-0.250 mil 3-6 μm), or a clear polyester laminate (0.5-10 mil, 13-254 μm) supporting common security features. These last two types of protective foil or laminate sometimes are applied at a laminating station separate from the printhead. The choice of laminate dictates the degree of durability and security imparted to the system in protecting the image and other data.

The terms “indicium” and indicia as used herein cover not only markings suitable for human reading, but also markings intended for machine reading, and include (but are not limited to) characters, symbols, codes, graphics, images, etc. Especially when intended for machine reading, such an indicium need not be visible to the human eye, but may be in the form of a marking visible only under infra-red, ultraviolet or other non-visible radiation. Thus, in at least some embodiments of the invention, an indicium formed on any layer in an identification document (e.g., the core layer) may be partially or wholly in the form of a marking visible only under non-visible radiation. Markings comprising, for example, a visible “dummy” image superposed over a nonvisible “real” image intended to be machine read may also be used.

“Laminate” and “overlaminate” include (but are not limited to) film and sheet products. Laminates usable with at least some embodiments of the invention include those which contain substantially transparent polymers and/or substantially transparent adhesives, or which have substantially transparent polymers and/or substantially transparent adhesives as a part of their structure, e.g., as an extruded feature. Examples of usable laminates include at least polyester, polycarbonate, polystyrene, cellulose ester, polyolefin, polysulfone, or polyamide. Laminates can be made using either an amorphous or biaxially oriented polymer as well. The laminate can include a plurality of separate laminate layers, for example a boundary layer and/or a film layer.

The degree of transparency of the laminate can, for example, be dictated by the information contained within the identification document, the particular colors and/or security features used, etc. The thickness of the laminate layers may vary, for example, in some implementations, the thickness of a laminate layer be about 1-20 mils. Lamination of laminate layer(s) to other layer of material (e.g., a core layer) can be accomplished using any conventional lamination process, and such processes are known to those skilled in the production of articles such as identification documents.

For example, in ID documents, a laminate can provide a protective covering for the printed substrates and provides a level of protection against unauthorized tampering (e.g., a laminate would have to be removed to alter the printed information and then subsequently replaced after the alteration.). Various lamination processes are disclosed in assignee's U.S. Pat. Nos. 5,783,024, 6,007,660, 6,066,594, and 6,159,327. Other lamination processes are disclosed, e.g., in U.S. Pat. Nos. 6,283,188 and 6,003,581. Each of these U.S. patents is herein incorporated by reference.

The material(s) from which a laminate is made may be transparent, but need not be. Laminates can include synthetic resin-impregnated or coated base materials composed of successive layers of material, bonded together via heat, pressure, and/or adhesive. Laminates also includes security laminates, such as a transparent laminate material with proprietary security technology features and processes, which protects documents of value from counterfeiting, data alteration, photo substitution, duplication (including color photocopying), and simulation by use of materials and technologies that are commonly available. Laminates also can include thermosetting materials, such as epoxy.

For purposes of illustration, the description explains ID document structures (e.g., TESLIN-core, multi-layered ID documents) and fused polycarbonate structures as example structures. The discussions herein are generally relevant to articles to which a laminate and/or coating is applied, including articles formed from paper, wood, cardboard, paperboard, glass, metal, plastic, fabric, ceramic, rubber, along with many man-made materials, such as microporous materials, single phase materials, two phase materials, coated paper, synthetic paper (e.g., TYVEC, manufactured by Dupont Corp of Wilmington, Del.), foamed polypropylene film (including calcium carbonate foamed polypropylene film), plastic, polyolefin, polyester, polyethylenetelphthalate (PET), PET-G, PET-F, and polyvinyl chloride (PVC), and combinations thereof.

FIG. 4 shows an example of a computing device 400 and a mobile computing device 450 that can be used to implement the techniques described here. The computing device 400 is intended to represent various forms of digital computers, such as laptops, desktops, workstations, personal digital assistants, servers, blade servers, mainframes, and other appropriate computers. The mobile computing device 450 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 400 includes a processor 402, a memory 404, a storage device 406, a high-speed interface 408 connecting to the memory 404 and multiple high-speed expansion ports 410, and a low-speed interface 412 connecting to a low-speed expansion port 414 and the storage device 406. Each of the processor 402, the memory 404, the storage device 406, the high-speed interface 408, the high-speed expansion ports 410, and the low-speed interface 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as a display 416 coupled to the high-speed interface 408. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 404 stores information within the computing device 400. In some implementations, the memory 404 is a volatile memory unit or units. In some implementations, the memory 404 is a non-volatile memory unit or units. The memory 404 may also be another form of computer-readable medium, such as a magnetic or optical disk.

The storage device 406 is capable of providing mass storage for the computing device 400. In some implementations, the storage device 406 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 402), perform one or more methods, such as those described above. The instructions can also be stored by one or more storage devices such as computer- or machine-readable mediums (for example, the memory 404, the storage device 406, or memory on the processor 402).

The high-speed interface 408 manages bandwidth-intensive operations for the computing device 400, while the low-speed interface 412 manages lower bandwidth-intensive operations. Such allocation of functions is an example only. In some implementations, the high-speed interface 408 is coupled to the memory 404, the display 416 (e.g., through a graphics processor or accelerator), and to the high-speed expansion ports 410, which may accept various expansion cards. In the implementation, the low-speed interface 412 is coupled to the storage device 406 and the low-speed expansion port 414. The low-speed expansion port 414, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. In addition, it may be implemented in a personal computer such as a laptop computer 422. It may also be implemented as part of a rack server system 424. Alternatively, components from the computing device 400 may be combined with other components in a mobile device, such as a mobile computing device 450. Each of such devices may contain one or more of the computing device 400 and the mobile computing device 450, and an entire system may be made up of multiple computing devices communicating with each other.

The mobile computing device 450 includes a processor 452, a memory 464, an input/output device such as a display 454, a communication interface 466, and a transceiver 468, among other components. The mobile computing device 450 may also be provided with a storage device, such as a micro-drive or other device, to provide additional storage. Each of the processor 452, the memory 464, the display 454, the communication interface 466, and the transceiver 468, are interconnected using various buses, and several of the components may be mounted on a common motherboard or in other manners as appropriate.

The processor 452 can execute instructions within the mobile computing device 450, including instructions stored in the memory 464. The processor 452 may be implemented as a chipset of chips that include separate and multiple analog and digital processors. The processor 452 may provide, for example, for coordination of the other components of the mobile computing device 450, such as control of user interfaces, applications run by the mobile computing device 450, and wireless communication by the mobile computing device 450.

The processor 452 may communicate with a user through a control interface 458 and a display interface 456 coupled to the display 454. The display 454 may be, for example, a TFT (Thin-Film-Transistor Liquid Crystal Display) display or an OLED (Organic Light Emitting Diode) display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. An expansion memory 474 may also be provided and connected to the mobile computing device 450 through an expansion interface 472, which may include, for example, a SIMM (Single In Line Memory Module) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provide as a security module for the mobile computing device 450, and may be programmed with instructions that permit secure use of the mobile computing device 450. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier such that the instructions, when executed by one or more processing devices (for example, processor 452), perform one or more methods, such as those described above. The instructions can also be stored by one or more storage devices, such as one or more computer- or machine-readable mediums (for example, the memory 464, the expansion memory 474, or memory on the processor 452). In some implementations, the instructions can be received in a propagated signal, for example, over the transceiver 468 or the external interface 462.

The mobile computing device 450 may communicate wirelessly through the communication interface 466, which may include digital signal processing circuitry where necessary. The communication interface 466 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 468 using a radio-frequency. In addition, short-range communication may occur, such as using a Bluetooth, WiFi, or other such transceiver. In addition, a GPS (Global Positioning System) receiver module 470 may provide additional navigation- and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound (e.g., voice messages, music files, etc.) and may also include sound generated by applications operating on the mobile computing device 450.

The mobile computing device 450 may be implemented in a number of different forms, as shown in the figure. For example, it may be implemented as a cellular telephone 480. It may also be implemented as part of a smart-phone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, while a client application is described as accessing the delegate(s), in other implementations the delegate(s) may be employed by other applications implemented by one or more processors, such as an application executing on one or more servers. In addition, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

What is claimed is:

1. A computer-implemented method comprising:
receiving a color image;
converting the color image to a grayscale image;
generating a foreground image by removing background pixels from the grayscale image;
determining a foreground pixel value range of the pixel values of the foreground image;
generating a transfer function based on the foreground pixel value range, a minimum pixel value, and a maximum pixel value;
generating a transferred image by applying the transfer function to each pixel of the foreground image; and
generating a monochrome image of the transferred image.

2. The method of claim 1, comprising:
generating a negative image of the grayscale image,
wherein generating the foreground image by removing the background pixels from the grayscale image comprises generating the foreground image by removing background pixels from the negative image.

3. The method of claim 1, comprising:
before generating the transfer function based on the foreground pixel value range, the minimum pixel value, and the maximum pixel value:
identifying a low group of pixel values that are the lowest pixel values of the foreground image;
identifying a high group of pixel values that are the highest pixel values of the foreground image;
replacing each pixel value in the low group of pixel values with a highest pixel value of the low group of pixel values; and
replacing each pixel value in the high group of pixel values with a lowest pixel value of the high group of pixel values.

4. The method of claim 3, wherein a number of pixels in the low group is equal to a number of pixels in the high group.

5. The method of claim 3, wherein a number of pixel values in the low group is equal to a number of pixel values in the high group.

6. The method of claim 1, wherein the transfer function is a linear transfer function.

7. The method of claim 1, wherein the monochrome image is a dithered monochrome image.

8. The method of claim 7, wherein the dithered monochrome image is a halftone image.

9. The method of claim 1, wherein the transfer function maps (i) a lowest foreground pixel value to the minimum pixel value and (ii) a highest foreground pixel value to the maximum pixel value.

10. The method of claim 1, wherein the transfer function maps each foreground pixel value to a different pixel value of the transferred image.

11. The method of claim 1, wherein the transfer function is a non-linear transfer function.

12. A system comprising:
one or more computers; and
one or more storage devices storing instructions that are operable, when executed by the one or more computers, to cause the one or more computers to perform operations comprising:
receiving a color image;
converting the color image to a grayscale image;
generating a foreground image by removing background pixels from the grayscale image;
determining a foreground pixel value range of the pixel values of the foreground image;
generating a transfer function based on the foreground pixel value range, a minimum pixel value, and a maximum pixel value;
generating a transferred image by applying the transfer function to each pixel of the foreground image; and
generating a monochrome image of the transferred image.

13. The system of claim 12, wherein the operations further comprise:
generating a negative image of the grayscale image,
wherein generating the foreground image by removing the background pixels from the grayscale image comprises generating the foreground image by removing background pixels from the negative image.

14. The system of claim 12, wherein the operations further comprise:
before generating the transfer function based on the foreground pixel value range, the minimum pixel value, and the maximum pixel value:
identifying a low group of pixel values that are the lowest pixel values of the foreground image;
identifying a high group of pixel values that are the highest pixel values of the foreground image;
replacing each pixel value in the low group of pixel values with a highest pixel value of the low group of pixel values; and
replacing each pixel value in the high group of pixel values with a lowest pixel value of the high group of pixel values.

15. The system of claim 12, wherein the transfer function is a linear transfer function.

16. The system of claim 12, wherein the monochrome image is a dithered monochrome image.

17. The system of claim 12, wherein the transfer function maps (i) a lowest foreground pixel value to the minimum pixel value and (ii) a highest foreground pixel value to the maximum pixel value.

18. The system of claim 12, wherein the transfer function maps each foreground pixel value to a different pixel value of the transferred image.

19. The system of claim 12, wherein the transfer function is a non-linear transfer function.

20. A non-transitory computer-readable medium storing software comprising instructions executable by one or more computers which, upon such execution, cause the one or more computers to perform operations comprising:
receiving a color image;
converting the color image to a grayscale image;
generating a foreground image by removing background pixels from the grayscale image;
determining a foreground pixel value range of the pixel values of the foreground image;
generating a transfer function based on the foreground pixel value range, a minimum pixel value, and a maximum pixel value;
generating a transferred image by applying the transfer function to each pixel of the foreground image; and
generating a monochrome image of the transferred image.
